(19) United States
(12) Patent Application Publication
(10) Pub. No.: US 2020/0234899 A1
(43) Pub. Date: Jul. 23, 2020

(54) ELECTROMAGNETIC RELAY UNIT AND ELECTROMAGNETIC RELAY SYSTEM

(71) Applicant: Panasonic Intellectual Property Management Co., Ltd., Osaka (JP)

(72) Inventors: YOSUKE SHIMIZU, Osaka (JP); KATSUTOSHI YAMAGATA, Hokkaido (JP)

(21) Appl. No.: 16/719,965

(22) Filed: Dec. 18, 2019

(30) Foreign Application Priority Data
Jan. 23, 2019 (JP) 2019-009545

(51) Int. Cl. H01H 50/12; H01H 50/04; H01H 50/14; H01H 50/02

(52) U.S. Cl. CPC H01H 50/12; H01H 50/04; H01H 50/546; H01H 50/023; H01H 2050/049; H01H 50/14

(57) ABSTRACT

An electromagnetic relay unit according to the present disclosure includes a first contact device, a second contact device, a first electromagnet device, a second electromagnet device, and a housing accommodating a first contact accommodation part and a second contact accommodation part. A first thermal conduction member is provided between the housing and the first contact accommodation part. A second thermal conduction member is provided between the housing and the second contact accommodation part.

### BACKGROUND

### 1. Technical Field

The present disclosure generally relates to an electromagnetic relay unit and an electromagnetic relay system. The present disclosure in particular relates to an electromagnetic relay unit and an electromagnetic relay system, including a movable part configured to move a movable contactor between a state where a fixed contact is not in contact with a movable contact and a state where the fixed contact is in contact with the movable contact, and an electromagnet device configured to drive the movable part.

### 2. Description of the Related Art

PTL 1 discloses an electromagnetic relay including a drive device including a winding and a coil bobbin, a contact device configured to be driven by the drive device, a lead wire electrically coupled to the winding, and a housing accommodating the drive device and the contact device.

### CITATION LIST

### Patent Literature

PTL 1: Unexamined Japanese Patent Publication No. 2017-195097

### SUMMARY

When a plurality of electromagnetic relays are provided in a device or a facility, for example, the electromagnetic relays may occupy a large volume in the device or the facility, for example, which would be problematic. When a plurality of electromagnetic relays are provided adjacent to each other, Joule heat generated at contacts in the electromagnetic relays would be less likely to dissipate from the electromagnetic relays.

An object of the present disclosure is to provide an electromagnetic relay unit and an electromagnetic relay system, in which a plurality of contacts can be open and closed, and from which Joule heat generated at the contacts easily dissipates.

An electromagnetic relay unit according to an aspect of the present disclosure includes a first contact device including a first fixed terminal including a first fixed contact, a first movable contactor including a first movable contact, a first movable part configured to move the first movable contactor between a first position and a second position, and a first contact accommodation part accommodating the first fixed contact and the first movable contact, a second contact device including a second fixed terminal including a second fixed contact, a second movable contactor including a second movable contact, a second movable part configured to move the second movable contactor between a third position and a fourth position, and a second contact accommodation part accommodating the second fixed contact and the second movable contact, a first electromagnet device configured to drive the first movable part, a second electromagnet device configured to drive the second movable part, a housing accommodating the first contact accommodation part and the second contact accommodation part, a first thermal conduction member provided between the housing and the first contact accommodation part, and a second thermal conduction member provided between the housing and the second contact accommodation part. When the first movable contactor is located at the first position, the first movable contact and the first fixed contact are separated from each other. When the first movable contactor is located at the second position, the first movable contact and the first fixed contact are in contact with each other. When the second movable contactor is located at the third position, the second movable contact and the second fixed contact are separated from each other. When the second movable contactor is located at the fourth position, the second movable contact and the second fixed contact are in contact with each other.

An electromagnetic relay system according to an aspect of the present disclosure includes the electromagnetic relay unit, and a controller configured to control the electromagnet device.

According to aspects of the present disclosure, an electromagnetic relay unit and an electromagnetic relay system, in which a plurality of contacts can be open and closed, and from which Joule heat generated at the contacts easily dissipates, can be achieved.

### BRIEF DESCRIPTION OF THE DRAWINGS

FIG. 1 is a perspective view of an electromagnetic relay unit according to an exemplary embodiment of the present disclosure;

FIG. 2 is a cross-sectional view seen from a front surface side of the electromagnetic relay unit according to the exemplary embodiment of the present disclosure;

FIG. 3 is a cross-sectional view seen from a left side surface side of the electromagnetic relay unit according to the exemplary embodiment of the present disclosure;

FIG. 4 is a cross-sectional perspective view of the electromagnetic relay unit according to the exemplary embodiment of the present disclosure;

FIG. 5 is a perspective view seen from a lower surface side of the electromagnetic relay unit according to the exemplary embodiment of the present disclosure;

FIG. 6 is a block diagram of an electromagnetic relay system according to the exemplary embodiment of the present disclosure;

FIG. 7 is an exploded perspective view seen from the lower surface side of the electromagnetic relay unit according to the exemplary embodiment of the present disclosure; and

FIG. 8 is a perspective view of the electromagnetic relay unit according to the exemplary embodiment of the present disclosure.

### DETAILED DESCRIPTION

One exemplary embodiment of the present disclosure will be described below.

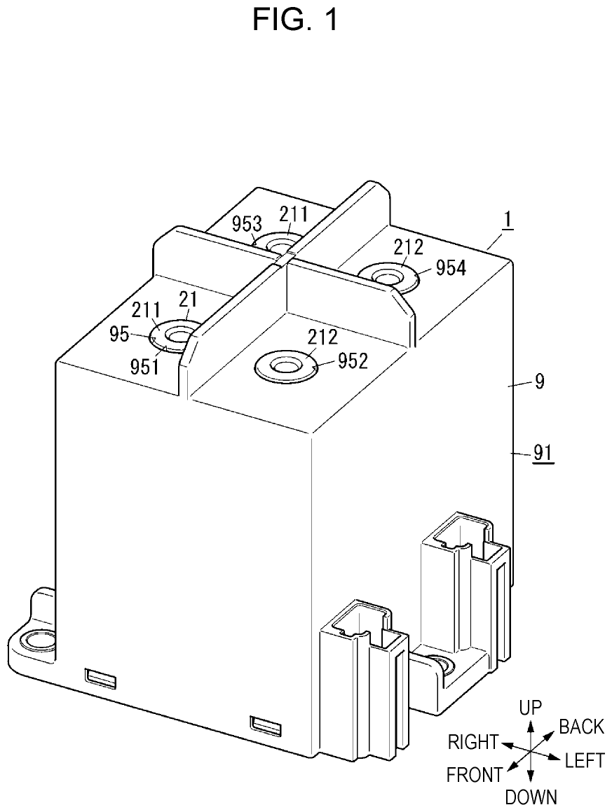

Electromagnetic relay unit 1 according to the present exemplary embodiment includes first contact device 201, second contact device 202, electromagnet device 5, housing 9, first space 81, second space 82, and thermal conduction member 6 (see FIGS. 1 to 5). First contact device 201 and second contact device 202 each include fixed terminal 21, movable contactor 24, movable part 3, and contact accommodation part 4. Fixed terminal 21 includes fixed contact 22. Movable contactor 24 includes movable contact 25. Movable part 3 moves, with respect to fixed terminal 21, movable contactor 24 between a non-contact position at which fixed contact 22 is not in contact with movable contact 25, and a contact position at which fixed contact 22 is in contact with movable contact 25.

When movable contactor 24 is located at the “non-contact position (a first position or a third position)”, movable contact 25 and fixed contact 22 are separated from each other. When movable contactor 24 is located at the “contact position (a second position or a fourth position)”, movable contact 25 and fixed contact 22 are in contact with each other.

Contact accommodation part 4 accommodates fixed contact 22 of fixed terminal 21 and movable contact 25.

Electromagnet device 5 drives movable part 3. Housing 9 accommodates contact accommodation part 4 of first contact device 201 and contact accommodation part 4 of second contact device 202. First space 81 is located between an inner surface of housing 9 and contact accommodation part 4 of first contact device 201. Second space 82 is located between the inner surface of housing 9 and contact accommodation part 4 of second contact device 202. Thermal conduction member 6 is disposed in first space 81 and second space 82.

According to the present exemplary embodiment, first contact device 201 and second contact device 202 in one electromagnetic relay unit 1 can each open and close the contacts. When electromagnetic relays are installed in a facility or a device, for example, that requires a plurality of contacts, a volume occupied by the electromagnetic relays can therefore be reduced. In the present exemplary embodiment, Joule heat is generated when movable contactor 24 is located at the contact position, and a current flows between movable contactor 24 and fixed terminal 21 in each of first contact device 201 and second contact device 202. In the present exemplary embodiment, however, Joule heat easily dissipates from contact accommodation part 4, via thermal conduction member 6 and housing 9, to outside of electromagnetic relay unit 1. First contact device 201 and second contact device 202 will thus likely tend to operate stably.

Electromagnetic relay unit 1 in which the plurality of contacts can be open and closed, and from which Joule heat generated at the contacts easily dissipates can thus be achieved.

The present exemplary embodiment will more specifically be described below. Hereinafter, a direction toward first contact device 201 and second contact device 202 with respect to electromagnet device 5 is referred to as an upward direction. A direction opposite to the upward direction is referred to as a downward direction. Directions including the upward and downward directions are referred to as vertical directions. Directions in which first contact device 201 and second contact device 202 are arranged are referred to as front-back directions. A direction toward second contact device 202 when viewed from first contact device 201 is referred to as a backward direction. A direction toward first contact device 201 when viewed from second contact device 202 is referred to as a forward direction. When a front of an observer is oriented in the forward direction and a back of the observer is oriented in the backward direction, a direction in which a right side of the observer faces is referred to as a rightward direction, and a direction in which a left side of the observer faces is referred to as a leftward direction. Directions including the rightward and leftward directions are referred to as horizontal directions. Unless otherwise clearly indicated herein, up, down, front, back, left, and right used below are specified based on the directions described above. For purpose of convenience, the directions are used for describing a structure of electromagnetic relay unit 1 according to the exemplary embodiment. Note that the directions do not specify directions and other orientations of electromagnetic relay unit 1 when electromagnetic relay unit 1 is used. The exemplary embodiment described below is merely one of various exemplary embodiments of the present disclosure. Various modifications may be made to the exemplary embodiment to suit design or other requirements as long as the object of the present disclosure is fulfilled. Drawings described in the below exemplary embodiment, for example, are merely schematic diagrams. Ratios in size and thickness of components in the drawings do not always reflect actual dimensional ratios.

The present exemplary embodiment will be described below with reference to FIGS. 1 to 5. Electromagnetic relay unit 1 according to the present exemplary embodiment includes first contact device 201, second contact device 202, electromagnet device 5, and housing 9. Housing 9 accommodates interior parts including first contact device 201, second contact device 202, and electromagnet device 5. In housing 9, first contact device 201 and second contact device 202 are disposed above electromagnet device 5. First contact device 201 and second contact device 202 are arranged in the front-back directions to allow second contact device 202 to be located behind first contact device 201.

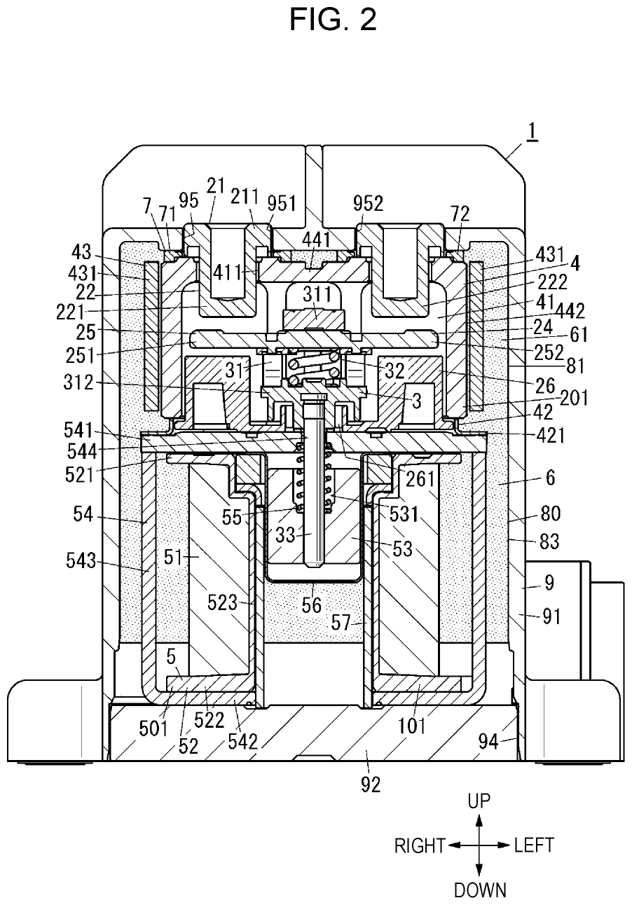

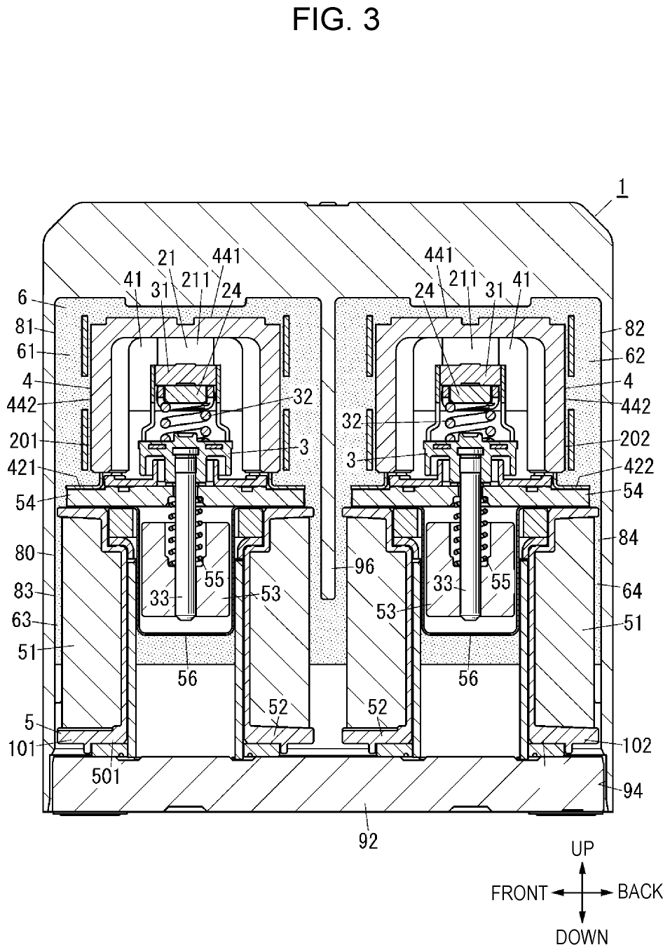

The interior parts will be described below (in particular, see FIGS. 2 and 3).

First contact device 201 and second contact device 202 each include fixed terminal 21, movable contactor 24, contact accommodation part 4, and movable part 3.

Fixed terminal 21 includes fixed contact 22. In the present exemplary embodiment, fixed terminal 21 includes fixed terminal 211 and fixed terminal 212. Fixed contact 22 includes fixed contact 221 and fixed contact 222. Fixed terminal 211 includes fixed contact 221. Fixed terminal 212 includes fixed contact 222. Fixed terminal 211 and fixed terminal 212 are each made of an electrically conductive material such as copper. Fixed terminal 211 and fixed terminal 212 are arranged in the horizontal directions. Fixed terminal 212 is located to a left side of fixed terminal 211. Fixed terminal 211 and fixed terminal 212 each have a cylindrical shape.

Fixed contact 221 facing downward is located at a lower end of fixed terminal 211. In the present exemplary embodiment, fixed terminal 211 is a member integral with fixed contact 221. A part at the lower end of fixed terminal 211 serves as fixed contact 221. Fixed terminal 211 may include a member that is a main body of fixed terminal 211, and fixed contact 221 that is attached at a lower end of the main body and that is another member than the main body. Fixed contact 222 facing downward is located at a lower end of fixed terminal 212. In the present exemplary embodiment, fixed terminal 212 is a member integral with fixed contact 222. A part at the lower end of fixed terminal 212 serves as fixed contact 222. Fixed terminal 212 may include a member that is a main body of fixed terminal 212, and fixed contact 222 that is attached to a lower end of the main body and that is another member than the main body.

Movable contactor 24 is made of an electrically conductive material such as copper. Movable contactor 24 includes movable contact 25. In the exemplary embodiment, movable contact 25 includes movable contact 251 and movable contact 252. Movable contactor 24 has a flat plate shape that is longer in the horizontal directions and has a thickness in the vertical directions. Movable contactor 24 is movable in the vertical directions. Movable contact 251 and movable contact 252 are respectively located at two end parts in the horizontal directions on an upper surface of movable contactor 24. Movable contact 251 is located below fixed contact 221. Movable contact 251 and fixed contact 221 face each other in the vertical directions. Movable contact 252 is located below fixed contact 222. Movable contact 252 and fixed contact 222 face each other in the vertical directions. In the present exemplary embodiment, movable contactor 24 is an integral member. A part of movable contactor 24 serves as movable contact 251. Another part of movable contactor 24 serves as movable contact 252. Movable contactor 24 may include a member that is a main body of movable contactor 24 and that has a flat plate shape, and movable contact 251 and movable contact 252 that are attached to the main body and that are other members than the main body.

Movable contactor 24 is movable with respect to fixed terminal 21 between a non-contact position at which fixed contact 22 is not in contact with movable contact 25 and a contact position at which fixed contact 22 is in contact with movable contact 25. At the non-contact position in the present exemplary embodiment, fixed contact 221 and fixed contact 222 are respectively not in contact with movable contact 251 and movable contact 252. At the contact position, fixed contact 221 and fixed contact 222 are respectively in contact with movable contact 251 and movable contact 252. Movable contactor 24 moves in either of the vertical directions between the non-contact position and the contact position.

Contact accommodation part 4 serves as a vessel accommodating fixed contact 22 of fixed terminal 21 and movable contactor 24. Contact accommodation part 4 is made of a non-magnetic, heat-resistant material such as ceramic. Contact accommodation part 4 has a box shape having a lower surface that is open. An upper surface of contact accommodation part 4 has two through holes 411 arranged in the horizontal directions. A space inside contact accommodation part 4 serves as accommodation chamber 41 accommodating fixed contact 22 (fixed contact 221 and fixed contact 222) and movable contactor 24. Accommodation chamber 41 is filled with arc-extinguishing gas such as hydrogen. Fixed terminal 211 and fixed terminal 212 are respectively inserted into through holes 411. Contact accommodation part 4 thus accommodates fixed contact 22 of fixed terminal 21. Upper ends of fixed terminal 211 and fixed terminal 212 respectively protrude upward from the upper surface of contact accommodation part 4. Fixed terminal 211 and fixed terminal 212 are respectively joined, through brazing, for example, to contact accommodation part 4.

Contact accommodation part 4 is further disposed with shield member 26. Shield member 26 has electrical insulating properties. Shield member 26 is made of a material having electrical insulating properties, such as ceramic or synthetic resin. Shield member 26 is disposed below movable contactor 24 in accommodation chamber 41. When an arc occurred between fixed contact 22 and movable contact 25 runs in front of or behind movable contactor 24, and extends below movable contactor 24, shield member 26 can come into contact with the arc to allow the arc to extend further, urging shielding of the arc. When movable contactor 24 moves from the contact position to the non-contact position, such an arc may occur between movable contact 25 and fixed contact 22. Shield member 26 has through hole 261 passing through in the vertical directions.

An outer surface of contact accommodation part 4 includes first surface 441 allowing fixed terminal 21 to be exposed externally, second surface 442 coupled to first surface 441 and surrounding the opening of contact accommodation part 4, fixed contact 22 (fixed contact 221 and fixed contact 222), and movable contactor 24. In the present exemplary embodiment, the upper surface of contact accommodation part 4 serves as first surface 441. An outer peripheral surface of contact accommodation part 4 serves as second surface 442.

Movable part 3 includes holder 31 and drive shaft 33.

Holder 31 is disposed in accommodation chamber 41. Holder 31 has top wall 311, bottom wall 312 coupled to top wall 311, and contact pressure spring 32. Top wall 311 is located above bottom wall 312. Top wall 311 and bottom wall 312 face each other at an interval in the vertical directions. Movable contactor 24 is inserted between top wall 311 and bottom wall 312. Contact pressure spring 32 is a compression coil spring, for example. Contact pressure spring 32 is disposed between bottom wall 312 and movable contactor 24 in a state where expansion and contraction directions conform to the vertical directions. Contact pressure spring 32 applies elastic force upward to movable contactor 24. That is, contact pressure spring 32 applies, to movable contactor 24, elastic force toward top wall 311. Movable contactor 24 being pinched between top wall 311 and contact pressure spring 32 is therefore held by holder 31.

Drive shaft 33 has a round bar shape. An axial direction of drive shaft 33 conforms to the vertical directions. An upper end of drive shaft 33 is coupled to holder 31. Drive shaft 33 is coupled to movable contactor 24 via holder 31. Drive shaft 33 is inserted into through hole 261 of shield member 26. A lower end of drive shaft 33 is protruding below contact accommodation part 4.

Electromagnetic relay unit 1 further includes magnetic flux generators 43 respectively corresponding to first contact device 201 and second contact device 202. Magnetic flux generators 43 each include two permanent magnets 431. Two permanent magnets 431 face each other with respect to contact accommodation part 4 in directions (horizontal directions) in which fixed contact 221 and fixed contact 222 are arranged. Otherwise, identical poles of two permanent magnets 431 may be arranged to face each other. Different poles of two permanent magnets 431 are arranged to face each other. That is, a north pole of one of two permanent magnets 431 and a south pole of another of two permanent magnets 431 are facing each other. Two permanent magnets 431 cause magnetic flux to occur in the horizontal directions in a space between fixed contact 22 and movable contact 25 (a space between fixed contact 221 and movable contact 251, and a space between fixed contact 222 and movable contact 252). It is preferable that magnetic flux in the horizontal directions are located around fixed contact 22 or movable contact 25. Magnetic flux generators 43 can each cause magnetic flux to occur in accommodation chamber 41 to allow an arc occurring between fixed contact 22 and movable contact 25 to extend. This can promptly extinguish the arc.

In the present exemplary embodiment, electromagnet device 5 includes first electromagnet device 501 and second electromagnet device 502. First electromagnet device 501 and second electromagnet device 502 each include excitation coil 51, coil bobbin 52, movable iron core 53, yoke 54, return spring 55, cylindrical member 56, and bushing 57. First electromagnet device 501 and second electromagnet device 502 each further include two coil terminals coupled to both ends of excitation coil 51.

Coil bobbin 52 is made of resin, for example. Coil bobbin 52 is wound with excitation coil 51. Coil bobbin 52 has two flange parts 521, 522, and cylindrical part 523. Cylindrical part 523 has a cylindrical shape having a central axis in the vertical directions. Cylindrical part 523 is wound with excitation coil 51. Flange part 521 extends from an upper end of cylindrical part 523 outward in radial directions of cylindrical part 523. Flange part 522 extends from a lower end of cylindrical part 523 outward in the radial directions of cylindrical part 523.

A shape of cylindrical member 56 corresponds to a bottomed cylindrical shape. The bottomed cylindrical shape has a central axis in the vertical directions, and an upper end that is open. Cylindrical member 56 is accommodated in cylindrical part 523.

Movable iron core 53 is made of a magnetic material. Movable iron core 53 is accommodated in cylindrical member 56. A shape of movable iron core 53 corresponds to a cylindrical shape having a central axis in the vertical directions. Movable iron core 53 is formed with recessed part 531 recessed downward from an upper surface of movable iron core 53.

Drive shaft 33 of movable part 3 of first contact device 201 is inserted into recessed part 531 of first electromagnet device 501. A lower end part of drive shaft 33 is fixed to movable iron core 53 of first electromagnet device 501. Drive shaft 33 of movable part 3 of second contact device 202 is inserted into recessed part 531 of second electromagnet device 502. A lower end part of drive shaft 33 is fixed to movable iron core 53 of second electromagnet device 502.

Yoke 54 is at least a part of a magnetic circuit through which magnetic flux generated in excitation coil 51 when excitation coil 51 is powered passes. Yoke 54 includes first yoke 541 having a plate shape, second yoke 542 having a plate shape, and two third yokes 543 each having a plate shape. First yoke 541 is disposed between movable contactor 24 and excitation coil 51. First yoke 541 abuts an upper surface of coil bobbin 52. Second yoke 542 abuts a lower surface of coil bobbin 52. Two third yokes 543 respectively extend from both left and right ends of second yoke 542 to first yoke 541. A shape of first yoke 541 corresponds to a rectangular plate shape. Through hole 544 is formed at a substantially center of first yoke 541. Drive shaft 33 is inserted into through hole 544.

Return spring 55 is a compression coil spring, for example. A first end (upper end) in the expansion and contraction directions (vertical directions) of return spring 55 abuts first yoke 541. A second end (lower end) abuts a bottom surface of recessed part 531 of movable iron core 53. Return spring 55 applies downward elastic force to movable iron core 53.

Bushing 57 is made of a magnetic material. A shape of bushing 57 corresponds to a cylindrical shape. Bushing 57 is disposed between an inner peripheral surface of coil bobbin 52 and an outer peripheral surface of cylindrical member 56. Bushing 57 constitutes, together with yoke 54 and movable iron core 53, the magnetic circuit through which magnetic flux generated when excitation coil 51 is powered passes.

Electromagnetic relay unit 1 further includes coupling body 42 coupling contact accommodation part 4 and electromagnet device 5. In the present exemplary embodiment, coupling body 42 includes first coupling body 421 coupling contact accommodation part 4 of first contact device 201 and first electromagnet device 501, and second coupling body 422 coupling contact accommodation part 4 of second contact device 202 and second electromagnet device 502. A shape of each of first coupling body 421 and second coupling body 422 corresponds to a rectangular frame shape. First coupling body 421 is joined, through brazing, to contact accommodation part 4 of first contact device 201, as well as is joined, through brazing, to yoke 54 included in first electromagnet device 501. Second coupling body 422 is joined, through brazing, to contact accommodation part 4 of second contact device 202, as well as is joined, through brazing, to yoke 54 included in second electromagnet device 502. The openings of contact accommodation parts 4 are thus closed by yokes 54. This also form first inner device 101 including first contact device 201 and first electromagnet device 501 coupled to first contact device 201, and second inner device 102 including second contact device 202 and second electromagnet device 502 coupled to second contact device 202.

Housing 9 will be described below. Housing 9 is made of resin, for example. Housing 9 includes accommodation part 91 and closure part 92. Accommodation part 91 has opening 94, and accommodates contact accommodation parts 4 and electromagnet device 5. In the exemplary embodiment, opening 94 is open downward. Closure part 92 is attached to accommodation part 91 to at least partially (in the present exemplary embodiment, wholly) close opening 94. Opening 94 has a substantially square shape. Closure part 92 has a substantially square shape corresponding to the shape of opening 94. Accommodation part 91 accommodates the interior parts including first contact device 201, second contact device 202, and electromagnet device 5 described above. Housing 9 thus accommodates first contact device 201, second contact device 202, and electromagnet device 5. In accommodation part 91, contact accommodation part 4 of first contact device 201 and contact accommodation part 4 of second contact device 202, electromagnet device 5, and opening 94 of accommodation part 91 are arranged in order from top. Closure part 92 thus is located below electromagnet device 5. Electromagnet device 5 and closure part 92 face each other in the vertical directions. Opening 94 therefore is located at a position opposite to contact accommodation parts 4 with respect to electromagnet device 5. Electromagnet device 5 and contact accommodation parts 4 are arranged in a direction orthogonal to a direction in which an opening face of opening 94 expands.

Housing 9 has first space 81 and second space 82. First space 81 is located between the inner surface of the housing and contact accommodation part 4 of first contact device 201. That is, first space 81 is a space between the inner surface of the housing and the outer surface of contact accommodation part 4 of first contact device 201. Second space 82 is located between the inner surface of housing 9 and contact accommodation part 4 of second contact device 202. That is, second space 82 is a space between the inner surface of housing 9 and the outer surface of contact accommodation part 4 of second contact device 202.

Housing 9 further has electromagnet-side space 80 between the inner surface of housing 9 and electromagnet device 5. In the present exemplary embodiment, electromagnet-side space 80 has third space 83 between the inner surface of housing 9 and first electromagnet device 501 and fourth space 84 between the inner surface of housing 9 and second electromagnet device 502. That is, third space 83 is a space between the inner surface of housing 9 and an outer surface of first electromagnet device 501. Fourth space 84 is a space between the inner surface of housing 9 and an outer surface of second electromagnet device 502.

In first space 81, other parts than contact accommodation part 4, such as permanent magnets 431 of magnetic flux generator 43, may be partially located between the inner surface of housing 9 and contact accommodation part 4. In second space 82, other parts than electromagnet device 5 may partially be located between the inner surface of housing 9 and electromagnet device 5. In third space 83, other parts than first electromagnet device 501 may partially be located between the inner surface of housing 9 and first electromagnet device 501. In fourth space 84, other parts than second electromagnet device 502 may be partially located between the inner surface of housing 9 and second electromagnet device 502.

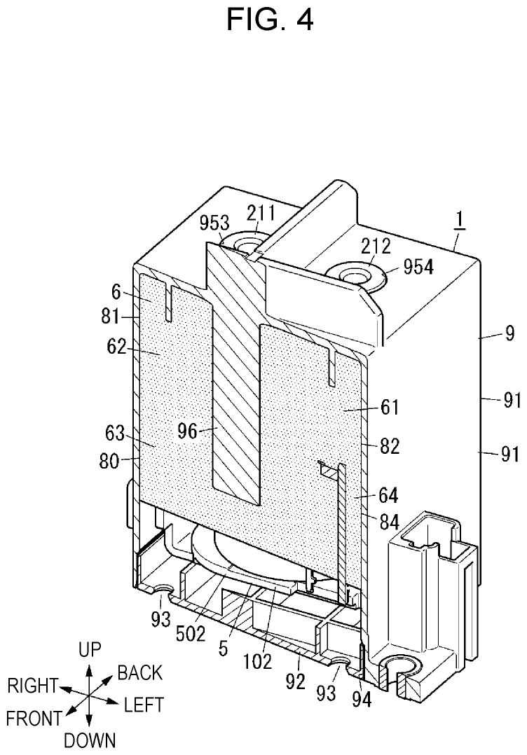

In the present exemplary embodiment, first space 81 is located adjacent to second space 82. First space 81 and second space 82 are in communication with each other (in particular, see FIGS. 3 and 4). That is, first space 81 and second space 82 constitute a single space. In the present exemplary embodiment, first space 81 and second space 82 both are located adjacent to electromagnet-side space 80. First space 81 and second space 82 are both in communication with electromagnet-side space 80. In electromagnet-side space 80, third space 83 is located adjacent to fourth space 84. Third space 83 and fourth space 84 are in communication with each other. That is, in the present exemplary embodiment, first space 81, second space 82, third space 83, and fourth space 84 constitute a single space.

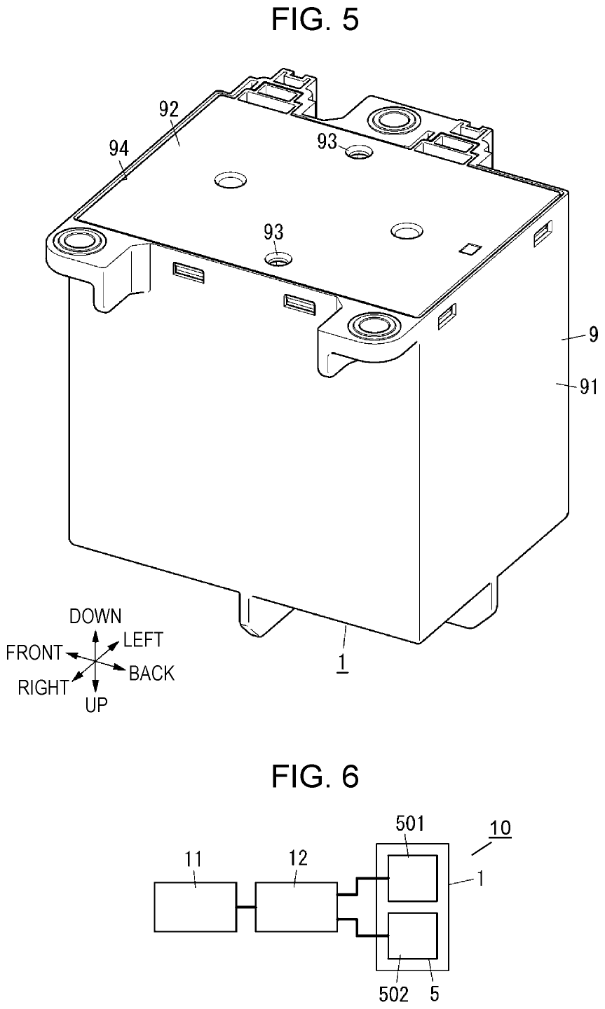

Housing 9 has through hole 93. Via through hole 93, first space 81 is in communication with outside of housing 9 (see FIGS. 4 and 5). Housing 9 may have a plurality of through holes 93. In the present exemplary embodiment, housing 9 has through holes 93 passing through closure part 92. Closure part 92 has two through holes 93. Through holes 93 according to the present exemplary embodiment are in communication with electromagnet-side space 80. First space 81 and second space 82 are both in communication with electromagnet-side space 80, as described above. Through holes 93 are thus in communication with first space 81 and second space 82 via electromagnet-side space 80.

Housing 9 has exposure opening 95 allowing fixed terminal 21 to be exposed to outside of housing 9. Exposure opening 95 is provided at a first end part (upper end part) of housing 9. Through holes 93 are provided at a second end part (lower end part), opposite to the first end part, of housing 9. Specifically, exposure opening 95 includes first exposure opening 951 corresponding to fixed terminal 211 in first contact device 201, and second exposure opening 952 corresponding to fixed terminal 212. Exposure opening 95 further includes third exposure opening 953 corresponding to fixed terminal 211 in second contact device 202, and fourth exposure opening 954 corresponding to fixed terminal 212. First exposure opening 951, second exposure opening 952, third exposure opening 953, and fourth exposure opening 954 all pass through an upper surface of accommodation part 91 in the vertical directions. First exposure opening 951 and second exposure opening 952 are arranged in the horizontal directions. Third exposure opening 953 and fourth exposure opening 954 are arranged in the horizontal directions. A combination of first exposure opening 951 and second exposure opening 952 and a combination of third exposure opening 953 and fourth exposure opening 954 are arranged in the front-back directions. Parts of fixed terminal 211 and fixed terminal 212 of first contact device 201 protrude from contact accommodation part 4, and are respectively inserted into first exposure opening 951 and second exposure opening 952. The upper end of fixed terminal 211 thus protrudes upward from first exposure opening 951. The upper end of fixed terminal 212 thus protrudes upward from second exposure opening 952. Fixed terminal 211 and fixed terminal 212 of first contact device 201 are thus exposed to outside of housing 9. There is a gap between fixed terminal 211 and first exposure opening 951. There is a gap between fixed terminal 212 and second exposure opening 952. Via the gaps, first space 81 is in communication with outside of housing 9. Similarly, parts of fixed terminal 211 and fixed terminal 212 of second contact device 202 protrude from contact accommodation part 4, and are respectively inserted into third exposure opening 953 and fourth exposure opening 954. The upper end of fixed terminal 211 thus protrudes upward from third exposure opening 953. The upper end of fixed terminal 212 thus protrudes upward from fourth exposure opening 954. Fixed terminal 211 and fixed terminal 212 of second contact device 202 are thus exposed to outside of housing 9. There is a gap between fixed terminal 213 and third exposure opening 953. There is a gap between fixed terminal 214 and fourth exposure opening 954. Via the gaps, second space 82 is in communication with outside of housing 9.

Housing 9 includes wall part 96 protruding downward from a surface, facing first surface 441 of contact accommodation part 4 of first contact device 201 and first surface 441 of contact accommodation part 4 of second contact device 202, on the inner surface of housing 9. Wall part 96 is located between contact accommodation part 4 of first contact device 201 and contact accommodation part 4 of second contact device 202 for partial partition. Wall part 96 can reinforce housing 9. A tip of wall part 96 is provided between first electromagnet device 501 and second electromagnet device 502. The tip of wall part 96 may be provided between first contact device 201 and second contact device 202.

Electromagnetic relay unit 1 includes seal material 7. Seal material 7 shields first space 81 and second space 82 from outside of housing 9 to disallow first space 81 and second space 82 to be in communication with outside of housing 9 via exposure opening 95. Seal material 7 between housing 9 and fixed terminal 21 can prevent foreign materials from entering housing 9. Seal material 7 is made of elastomer having elasticity, such as silicone rubber. In the present exemplary embodiment, seal material 7 includes first seal material 71 for fixed terminal 211 of first contact device 201, and second seal material 72 for fixed terminal 212 of first contact device 201. Seal material 7 further includes third seal material 73 for fixed terminal 211 of second contact device 202, and fourth seal material 74 for fixed terminal 212 of second contact device 202. First seal material 71 and second seal material 72 respectively seal first space 81 to prevent first exposure opening 951 and second exposure opening 952 from being in communication with outside of housing 9. Third seal material 73 and fourth seal material 74 respectively seal first space 81 to prevent third exposure opening 953 and fourth exposure opening 954 from being in communication with outside of housing 9. Seal material 7 thus seals a route allowing first space 81 and housing 9 to be in communication with each other via first exposure opening 951 and second exposure opening 952.

More specifically, first to fourth seal materials 71 to 74 each have a ring shape. Between the upper surfaces of contact accommodation parts 4 and the inner surface of housing 9 (an inner surface of accommodation part 91), first to fourth seal materials 71 to 74 respectively abut the upper surfaces of contact accommodation parts 4. Between the upper surface of contact accommodation part 4 and the inner surface of housing 9 (the inner surface of accommodation part 91) in first contact device 201, first and second seal materials 71 and 72 abut the upper surface of contact accommodation part 4. Furthermore, first seal material 71 and second seal material 72 respectively abut edges of first exposure opening 951 and second exposure opening 952 on the inner surface of housing 9. It is preferable that first and second seal materials 71 and 72 be respectively pinched between housing 9 and contact accommodation part 4, and be compression-deformed. First seal material 71 and second seal material 72 respectively surround fixed contact 221 and fixed contact 222. Specifically, first seal material 71 surrounds and abuts an outer peripheral surface of fixed contact 221. Second seal material 72 surrounds and abuts an outer peripheral surface of fixed contact 222. Similarly, between the upper surface of contact accommodation part 4 and the inner surface of housing 9 (the inner surface of accommodation part 91) in second contact device 202, third and fourth seal materials 73 and 74 abut the upper surface of contact accommodation part 4. Furthermore, third seal material 73 and fourth seal material 74 respectively abut edges of third exposure opening 953 and fourth exposure opening 954 on the inner surface of housing 9. It is preferable that third and fourth seal materials 73 and 74 be respectively pinched between housing 9 and contact accommodation part 4, and be compression-deformed. Third seal material 73 and fourth seal material 74 respectively surround fixed contact 223 and fixed contact 224. Specifically, third seal material 73 surrounds and abuts an outer peripheral surface of fixed contact 223. Fourth seal material 74 surrounds and abuts an outer peripheral surface of fixed contact 224.

That is, seal material 7 is provided to cover the gaps between housing 9 and fixed terminal 21.

Seal material 7 may be disposed in the gaps between housing 9 and fixed terminal 21 in exposure opening 95. Seal material 7 may thus shield first space 81 from outside of housing 9.

Thermal conduction member 6 may be a member higher in thermal conductivity than air. Thermal conduction member 6 is made of resin, for example. Thermal conduction member 6 is produced by forming a two-component urethane resin composition, and then allowing a product to be reacted and hardened, for example. That is, thermal conduction member 6 is a potting agent. Thermal conduction member 6 is disposed in first space 81 and second space 82, as described above. In the present exemplary embodiment, thermal conduction member 6 is also disposed in electromagnet-side space 80. In electromagnet-side space 80, thermal conduction member 6 is disposed in third space 83 and fourth space 84. Thermal conduction member 6 may be at least partially disposed in first space 81 and second space 82. Thermal conduction member 6 may be at least partially disposed in third space 83 and fourth space 84.

In the present exemplary embodiment, thermal conduction member 6 has first part 61 disposed in first space 81, and second part 62 disposed in second space 82. In the present exemplary embodiment, thermal conduction member 6 further has third part 63 disposed in third space 83, and fourth part 64 disposed in fourth space 84.

In the present exemplary embodiment, first part 61 of thermal conduction member 6 and second part 62 of thermal conduction member 6 are successively coupled to each other via another part of thermal conduction member 6. That is, first part 61 and second part 62 each constitute a part of thermal conduction member 6 that is a single member. In other words, first part 61 of thermal conduction member 6, second part 62 of thermal conduction member 6, and a thermal conduction member coupling first part 61 and second part 62 are integrally formed. In this case, first part 61 may be disposed in first space 81 wholly or in first space 81 partially. Second part 62 may be disposed in second space 82 wholly or in second space 82 partially.

In the present exemplary embodiment, third part 63 and fourth part 64 are successively coupled to each other in electromagnet-side space 80 via another part of thermal conduction member 6. That is, third part 63 and fourth part 64 each constitute a part of thermal conduction member 6 that is a single member. In this case, third part 63 may be disposed in third space 83 wholly or in third space 83 partially. Fourth part 64 may be disposed in fourth space 84 wholly or in fourth space 84 partially.

In the present exemplary embodiment, third part 63 and fourth part 64 are respectively similar to first part 61 and second part 62. That is, third part 63 of thermal conduction member 6, fourth part 64 of thermal conduction member 6, and a thermal conduction member coupling third part 63 and fourth part 64 are integrally formed.

In the present exemplary embodiment, first part 61 and second part 62 are successively coupled to electromagnet-side space 80. That is, first part 61, second part 62, third part 63, and fourth part 64 each constitute a part of thermal conduction member 6 that is a single member.

In other words, in the present exemplary embodiment, first part 61 of thermal conduction member 6, second part 62 of thermal conduction member 6, the thermal conduction member coupling first part 61 and second part 62, third part 63 of thermal conduction member 6, fourth part 64 of thermal conduction member 6, and the thermal conduction member coupling third part 63 and fourth part 64 are integrally formed.

In first space 81, it is preferable that thermal conduction member 6 (first part 61) abut contact accommodation part 4 and the inner surface of housing 9. In this case, heat generated at the contacts in first contact device 201 easily dissipates from contact accommodation part 4, via thermal conduction member 6 and housing 9, to outside of electromagnetic relay unit 1. In second space 82, it is preferable that thermal conduction member 6 (second part 62) abut contact accommodation part 4 and the inner surface of housing 9.

In this case, heat generated at the contacts in second contact device 202 easily dissipates from contact accommodation part 4, via thermal conduction member 6 and housing 9, to outside of electromagnetic relay unit 1. In third space 83, it is preferable that thermal conduction member 6 (third part 63) abut first electromagnet device 501 and the inner surface of housing 9. In this case, heat generated in first electromagnet device 501 easily dissipates, via thermal conduction member 6 and housing 9, to outside of electromagnetic relay unit 1. In fourth space 84, it is preferable that thermal conduction member 6 (fourth part 64) abut second electromagnet device 502 and the inner surface of housing 9. In this case, heat generated in second electromagnet device 502 easily dissipates, via thermal conduction member 6 and housing 9, to outside of electromagnetic relay unit 1. Specifically, the third space and the fourth space each include a space between housing 9 and yoke 54 and a space between excitation coil 51 and yoke 54. It is preferable that thermal conduction member 6 be disposed in at least either of the space between housing 9 and yoke 54 and the space between excitation coil 51 and yoke 54. It is more preferable that thermal conduction member 6 be disposed in both of the spaces. Thermal conduction member 6 may be disposed between two flange parts 521, 522 of coil bobbin 52.

In the present exemplary embodiment, first space 81 is a space between the outer surface of contact accommodation part 4 of first contact device 201 and, in housing 9, an inner surface of a part surrounding contact accommodation part 4 of first contact device 201. As described above, the outer surface of contact accommodation part 4 has first surface 441 and second surface 442. First space 81 thus includes a space between first surface 441 and the inner surface of housing 9 and a space between second surface 442 and the inner surface of housing 9. It is preferable that thermal conduction member 6 (first part 61) be disposed in at least either of the space between first surface 441 and the inner surface of housing 9 and the space between second surface 442 and the inner surface of housing 9. It is more preferable that thermal conduction member 6 (first part 61) be disposed in both of the spaces. In this case, heat generated at the contacts in first contact device 201 further easily dissipates from contact accommodation part 4, via thermal conduction member 6 and housing 9, to outside of electromagnetic relay unit 1. In the present exemplary embodiment, second space 82 is a space between the outer surface of contact accommodation part 4 of second contact device 202 and, in housing 9, an inner surface of a part surrounding contact accommodation part 4 of second contact device 202. As described above, the outer surface of contact accommodation part 4 has first surface 441 and second surface 442. Second space 82 thus includes a space between first surface 441 and the inner surface of housing 9 and a space between second surface 442 and the inner surface of housing 9. It is preferable that thermal conduction member 6 (second part 62) be disposed in at least either of the space between first surface 441 and the inner surface of housing 9 and the space between second surface 442 and the inner surface of housing 9. It is more preferable that thermal conduction member 6 (second part 62) be disposed in both of the spaces. In this case, heat generated at the contacts in second contact device 202 further easily dissipates from contact accommodation part 4, via thermal conduction member 6 and housing 9, to outside of electromagnetic relay unit 1.

As described above, in the present exemplary embodiment, first part 61 and second part 62 are successively coupled to each other. Joule heat generated at the contacts in first contact device 201 is transmitted to housing 9 via not only first part 61, but also second part 62. Joule heat then dissipates, via housing 9, to outside of electromagnetic relay unit 1. Joule heat generated at the contacts in first contact device 201 thus further easily dissipates. Similarly, Joule heat generated at the contacts in second contact device 202 is transmitted to housing 9 via not only second part 62, but also first part 61. Joule heat then dissipates, via housing 9, to outside of electromagnetic relay unit 1. Joule heat generated at the contacts in second contact device 202 thus further easily dissipates.

Operation of electromagnetic relay unit 1 according to the present exemplary embodiment will be described below.

As electromagnet device 5 generates electromagnetic force that drives movable part 3, movable part 3 is driven. Movable part 3 thus moves movable contactor 24 from the non-contact position to the contact position.

In the present exemplary embodiment, as first electromagnet device 501 generates electromagnetic force that drives movable part 3 of first contact device 201, movable part 3 of first contact device 201 is driven. Movable part 3 thus moves movable contactor 24 of first contact device 201 from the non-contact position to the contact position. As second electromagnet device 502 generates electromagnetic force that drives movable part 3 of second contact device 202, movable part 3 of second contact device 202 is driven. Movable part 3 thus moves movable contactor 24 of second contact device 202 from the non-contact position to the contact position.

Specifically, as excitation coil 51 is powered, magnetic flux generated in excitation coil 51 passes through the magnetic circuit, generating electromagnetic force that causes movable iron core 53 to move upward to reduce magnetic resistance in the magnetic circuit. As the electromagnetic force overcomes force (elastic force) of return spring 55 pushing downward movable iron core 53, movable iron core 53 moves upward to fill a gap between first yoke 541 and an upper end of movable iron core 53 in the magnetic circuit. Electromagnet device 5 thus drives movable part 3.

As movable iron core 53 moves upward, drive shaft 33 and holder 31 in movable part 3 also move upward. Movable contactor 24 held by holder 31 accordingly moves upward. As a result, movable contactor 24 reaches the contact position. Fixed contact 221 and fixed contact 222 are thus electrically coupled to each other via movable contactor 24. That is, fixed terminal 211 and fixed terminal 212 are electrically coupled to each other.

When a state where excitation coil 51 is powered switches to a state where excitation coil 51 is not powered while movable contactor 24 is located at the contact position, the electromagnetic force that causes movable iron core 53 to move upward disappears. Movable iron core 53 accordingly moves downward by the elastic force of return spring 55. As a result, movable contactor 24 moves downward. Movable contactor 24 thus reaches the non-contact position. Such a state is thus attained that fixed terminal 211 and fixed terminal 212 are not electrically coupled to each other.

When a voltage is applied between fixed terminal 211 and fixed terminal 212 while movable contactor 24 is located at the contact position, a current flows between fixed terminal 211 and movable contactor 24 and between movable contactor 24 and fixed terminal 212, generating Joule heat. In the present exemplary embodiment, Joule heat easily dissipates from contact accommodation part 4 to outside of electromagnetic relay unit 1 via thermal conduction member 6 and housing 9. Movable contactor 24 and fixed terminal 21 would thus be less likely to rise in temperature excessively. As a result, electromagnetic relay unit 1 will likely tend to operate stably.

In the present exemplary embodiment, as thermal conduction member 6 is also disposed in electromagnet-side space 80 (third space 83 and fourth space 84), heat generated in electromagnet device 5 also easily dissipates to outside of electromagnetic relay unit 1 via thermal conduction member 6 and housing 9. Electromagnet device 5 would thus be less likely to rise in temperature excessively. As a result, electromagnetic relay unit 1 will likely tend to operate stably.

When thermal conduction member 6 or its raw material is to be disposed in first space 81, seal material 7 can suppress thermal conduction member 6 or its raw material from leaking from first space 81 to outside of housing 9. Thermal conduction member 6 with which first space 81 is filled fully can thus be easily produced. With the present exemplary embodiment, electromagnetic relay unit 1 in which Joule heat generated at contacts easily dissipates can thus be easily acquired.

In electromagnetic relay unit 1 according to the present exemplary embodiment, it is preferable that, when movable contactor 24 of first contact device 201 is located at the contact position, movable contactor 24 of second contact device 202 is located at the non-contact position. It is preferable that, when movable contactor 24 of second contact device 202 is located at the contact position, movable contactor 24 of first contact device 201 is located at the non-contact position. It is preferable that movable contactors 24 respectively of first contact device 201 and second contact device 202 in electromagnet device 5 be driven to allow movable contactors 24 to operate as described above. As movable contactors 24 operate as described above, no Joule heat is generated in second contact device 202 even though Joule heat is generated in first contact device 201. Efficient transmission of Joule heat generated at the contacts in first contact device 201 can thus be achieved. Similarly, no Joule heat is generated in first contact device 201 even though Joule heat is generated in second contact device 202. Efficient transmission of Joule heat generated at the contacts in second contact device 202 can thus be achieved. In particular, in the present exemplary embodiment, first part 61 and second part 62 of thermal conduction member 6 are successively coupled to each other. Thermal conduction member 6 can thus utilize both of first part 61 and second part 62 to transmit only either of Joule heat generated at the contacts in first contact device 201 and Joule heat generated at the contacts in second contact device 202. Efficiency of allowing Joule heat generated at the contacts in first contact device 201 and second contact device 202 respectively to dissipate can further be increased.

Electromagnetic relay system 10 including electromagnetic relay unit 1 and controller 11 will be described below (see FIG. 6).

Controller 11 controls electromagnet device 5 of electromagnetic relay unit 1. Controller 11 can therefore open-close control the contacts in first contact device 201 and second contact device 202 respectively.

Specifically, controller 11 can adjust a current supplied to excitation coil 51 in first electromagnet device 501 to control operation of first electromagnet device 501, thereby open-close controlling the contacts in first contact device 201. Controller 11 can further adjust a current supplied to excitation coil 51 in second electromagnet device 502 to control operation of second electromagnet device 502, thereby open-close controlling the contacts in second contact device 202.

FIG. 6 is a block diagram illustrating an example of a configuration of electromagnetic relay system 10. Electromagnetic relay system 10 includes electromagnetic relay unit 1, power supply circuit 12, and controller 11. Power supply circuit 12 supplies a current to excitation coil 51 of first electromagnet device 501 and excitation coil 51 of second electromagnet device 502, respectively, in electromagnetic relay unit 1. Controller 11 controls power supply circuit 12 to adjust a current supplied to excitation coil 51 in first electromagnet device 501 and a current supplied to excitation coil 51 in second electromagnet device 502, respectively. That is, controller 11 controls power supply circuit 12 to control electromagnet device 5. Controller 11 controls power supply circuit 12 in accordance with a signal that enters controller 11, for example.

Controller 11 includes a microcomputer including one or more processors and one or more memories, for example. In other words, controller 11 is implemented by a computer system including one or more processors and one or more memories. The one or more processors execute programs stored in the one or more memories, allowing the computer system to function as controller 11. Herein, the programs are recorded in the one or more memories of controller 11 in advance. However, the programs may be provided via a communication line such as the Internet or from a non-transitory recording medium such as memory card recording the programs. Such a computer program product may be used that loads a program via a computer system to execute program instructions that cause the computer system to achieve functions as controller 11. Controller 11 is not limited to such a microcomputer, but may be an integrated circuit including logic circuits, such as an application specific integrated circuit (ASIC).

It is preferable that, when movable contactor 24 of first contact device 201 is located at the contact position, controller 11 control electromagnet device 5 to allow movable contactor 24 of second contact device 202 to be located at the non-contact position. It is also preferable that, when movable contactor 24 of second contact device 202 is located at the contact position, controller 11 control electromagnet device 5 to allow movable contactor 24 of first contact device 201 to be located at the non-contact position. In this case, as described above, efficiency of allowing Joule heat generated at the contacts in first contact device 201 and second contact device 202 respectively to dissipate can further be increased.

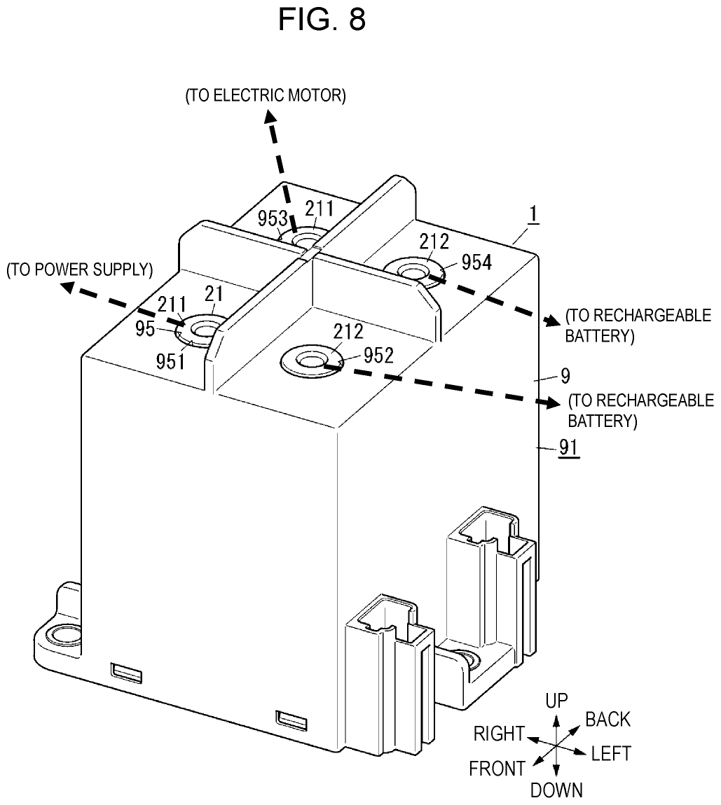

Electromagnetic relay unit 1 and electromagnetic relay system 10 are installed in an electric vehicle that includes, for example, a rechargeable battery, and an electric motor that uses electric power supplied from the rechargeable battery for its operation. In this case, as illustrated in FIG. 8, for example, first contact device 201 in electromagnetic relay unit 1 is coupled to an electric path between an external power supply for the electric vehicle and the rechargeable battery. Second contact device 202 is coupled to an electric path between the rechargeable battery and the electric motor. That is, one of fixed terminal 211 and fixed terminal 212 in first contact device 201 is electrically coupled to the power supply. The other is electrically coupled to the rechargeable battery. One of fixed terminal 211 and fixed terminal 212 in second contact device 202 is electrically coupled to the rechargeable battery. The other is electrically coupled to the electric motor. In this case, one electromagnetic relay unit 1 can open and close the contacts in the different two electric paths. When the contacts are closed in the electric path between the external power supply and the rechargeable battery to charge the rechargeable battery, for example, electromagnetic relay unit 1 can open the contacts in the electric path between the rechargeable battery and the electric motor to prevent a current from being supplied from the rechargeable battery to the electric motor. While the contacts in the electric path between the rechargeable battery and the electric motor are closed, a current is supplied from the rechargeable battery to the electric motor, and the electric motor is driven, electromagnetic relay unit 1 can open the contacts in the electric path between the external power supply and the rechargeable battery. In this case, electromagnetic relay unit 1 can be operated to cause second contact device 202 to open the contacts when first contact device 201 is closing the contacts, and to cause first contact device 201 to open the contacts when second contact device 202 is closing the contacts. In this case, when movable contactor 24 of first contact device 201 is located at the contact position, movable contactor 24 of second contact device 202 is located at the non-contact position. When movable contactor 24 of second contact device 202 is located at the contact position, movable contactor 24 of first contact device 201 is located at the non-contact position. In this case, as described above, efficiency of allowing Joule heat generated at the contacts in first contact device 201 and second contact device 202 respectively to dissipate can further be increased.

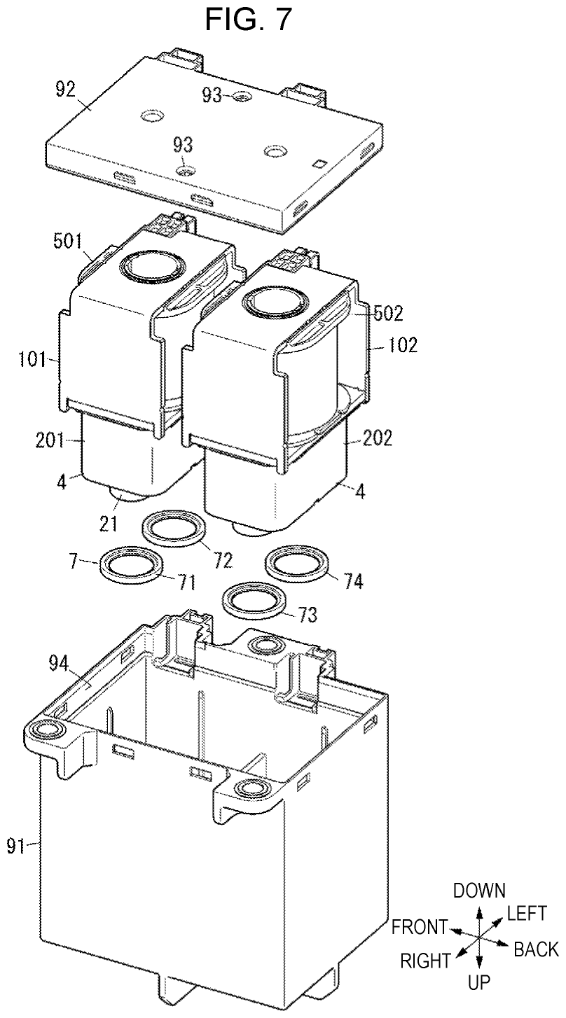

An example of a method of producing thermal conduction member 6 according to the exemplary embodiment will be described with reference to FIG. 7.

Accommodation part 91, closure part 92, seal material 7, and the interior parts are prepared. In FIG. 7, the interior parts other than first inner device 101 and second inner device 102 are omitted.

The interior parts including first inner device 101 and second inner device 102 are first placed in accommodation part 91 from opening 94 of accommodation part 91. At this time, seal material 7 is disposed at a position between first inner device 101 and accommodation part 91 and between second inner device 102 and accommodation part 91, as described above. Seal material 7 between housing 9 and fixed terminal 21 thus shields first space 81 and second space 82 from outside of housing 9.

Next, closure part 92 is attached to accommodation part 91 to close opening 94 with closure part 92. In this state, thermal conduction member 6 is not disposed in first space 81, second space 82, and electromagnet-side space 80. An intermediate product of electromagnetic relay unit 1 without including thermal conduction member 6 is thus acquired.

Next, the intermediate product is disposed in a state reversed from the state as described above. That is, the intermediate product is disposed in a state where opening 94 of accommodation part 91 faces upward, whereas fixed terminal 21 faces downward. In this state, the raw material of thermal conduction member 6 is placed, into housing 9, from one of two through holes 93 (i.e., two through holes 93 passing through closure part 92) of housing 9. At this time, it is preferable that another of through holes 93 be not closed. The raw material of thermal conduction member 6 is, for example, a reactive hardening resin composition having flow properties, such as a two-component urethane resin composition. That is, the raw material is a potting agent. In this case, as the raw material of thermal conduction member 6 is placed from the one of through holes 93 into housing 9, gas such as air in housing 9 easily exits from the other of through holes 93 to outside of housing 9. The raw material of the thermal conductive member can thus be easily placed into housing 9. The raw material of thermal conduction member 6 is placed into housing 9 until first space 81 and second space 82 are partially or fully filled with the raw material, or electromagnet-side space 80 is partially or further fully filled with the raw material, for example. A quantity of the raw material in housing 9 can be checked by observing inside of housing 9 via through holes 93, for example.

When the raw material is to be placed into housing 9, fixed terminal 21 faces downward. If there is a gap between housing 9 and fixed terminal 21, the raw material may accordingly leak from the gap. In the exemplary embodiment, however, as described above, before the raw material is placed into housing 9, seal material 7 is shielding the route through which first space 81 and second space 82 are in communication with outside of housing 9 via exposure opening 95. The raw material would thus be less likely to leak from the gap between fixed terminal 21 and exposure opening 95. The raw material can thus be easily disposed in first space 81 and second space 82.

Next, the raw material in housing 9 is heated as required, for example, to allow the raw material to be hardened. Thermal conduction member 6 made of a cured product of the raw material is thus produced.

The present disclosure is not limited to the exemplary embodiment described above. For example, the present disclosure may include modification examples in which the specific configuration of the exemplary embodiment described above is altered. Such modification examples to the present disclosure will be described below. It is to be noted herein that like reference numerals designate identical or corresponding components of the exemplary embodiment described above, and their detailed descriptions are appropriately omitted.

In the exemplary embodiment described above, electromagnetic relay unit 1 includes the two contact devices, i.e., first contact device 201 and second contact device 202. However, electromagnetic relay unit 1 may include three or more contact devices.

In the exemplary embodiment described above, the electromagnet device includes first electromagnet device 501 and second electromagnet device 502 that respectively drive the movable part of first contact device 201 and the movable part of second contact device 202. However, the electromagnet device may include only one electromagnet device that simultaneously drive the movable part of first contact device 201 and the movable part of second contact device 202.

In the exemplary embodiment described above, thermal conduction member 6 is disposed in first space 81 and second space 82, as well as in electromagnet-side space 80. However, thermal conduction member 6 may be disposed in first space 81 and second space 82, and may not be disposed in electromagnet-side space 80. It is preferable that first space 81 and second space 82 be wholly filled with thermal conduction member 6. However, first space 81 or second space 82 may only partially filled with thermal conduction member 6. As described above, it is however preferable that thermal conduction member 6 be disposed in at least either of the space between first surface 441 of each of contact accommodation parts 4 and the inner surface of housing 9, and the space between second surface 442 and the inner surface of housing 9. It is more preferable that thermal conduction member 6 be disposed in both of the spaces.

It is preferable that thermal conduction member 6 abut at least either of the inner surface of housing 9 and the outer surface of contact accommodation part 4. It is more preferable that thermal conduction member 6 abut both of the surfaces, as can be seen in the exemplary embodiment described above.

As long as fixed contact 22 of fixed terminal 21 and movable contactor 24 are accommodated, contact accommodation part 4 is not limited in configuration to the exemplary embodiment described above. As long as movable part 3 can be driven by electromagnet device 5 to move movable contactor 24, movable part 3 is not limited in configuration to the exemplary embodiment described above. Movable part 3 may include combinations of appropriate mechanical components that transmit power used to move movable contactor 24 from electromagnet device 5 to movable contactor 24.

In the exemplary embodiment described above, seal material 7 has a ring shape. However, seal material 7 may have an appropriate shape in accordance with the shape of fixed terminal 21, for example. In the exemplary embodiment described above, seal material 7 is made of elastomer. However, seal material 7 between housing 9 and fixed terminal 21 may be a hard member, as long as first space 81 and second space 82 can be shielded from outside of housing 9.

When housing 9 has through hole 93, through hole 93 is not limited in position and number to the exemplary embodiment described above. A number of through holes 93 may be one, three, or more.

Through hole 93 may be positioned at any position, as long as through hole 93 is in communication with first space 81 and second space 82. For example, housing 9 may have through hole 93 surrounded by a part of an inner peripheral edge of opening 94 of accommodation part 91 and a part of an outer peripheral edge of closure part 92. That is, closure part 92 may partially close opening 94. A part that is not closed by closure part 92 in opening 94 may serve as through hole 93. Housing 9 may have through hole 93 passing through accommodation part 91. For example, through hole 93 may be located on a side surface of housing 9. In the exemplary embodiment described above, through holes 93 are respectively in communication with first space 81 and second space 82 via electromagnet-side space 80. However, such through hole 93 may be provided that is directly in communication with first space 81 or second space 82.

In the exemplary embodiment described above, housing 9 includes a combination of one accommodation part 91 and one closure part 92. However, housing 9 may include a combination of three or more members. For example, accommodation part 91 according to the exemplary embodiment described above may include a combination of a box member that is open downward and a cylindrical member attached to the box member.

In electromagnetic relay unit 1 according to the present disclosure, such an effect particularly significantly appears that Joule heat generated at the contacts easily dissipates even when a large current flows in electromagnetic relay unit 1. However, purposes of electromagnetic relay unit 1 according to the present disclosure are not limited to allowing a large current to flow. Regardless of a value of a current flowing into electromagnetic relay unit 1, such an effect can be acquired with the present disclosure that Joule heat generated at the contacts easily dissipates.

The present disclosure includes not only the exemplary embodiment and the modification examples described above, but also combinations of the exemplary embodiment and the modification examples described above.

Purposes of electromagnetic relay unit 1 and electromagnetic relay system 10 are not limited to being provided in an electric vehicle. Even when electromagnetic relay unit 1 and electromagnetic relay system 10 are provided in any device or facility, for example, one electromagnetic relay unit 1 can open and close two contacts. Joule heat generated at the contacts easily and efficiently dissipates from electromagnetic relay unit 1.

### SUMMARY

As is apparent from the exemplary embodiment and the modification examples described above, electromagnetic relay unit 1 according to an aspect of the present disclosure includes first contact device 201 including fixed terminal 21 including fixed contact 22, movable contactor 24 including movable contact 25, movable part 3 configured to move movable contactor 24 between a first position and a second position, and contact accommodation part 4 accommodating fixed contact 22 and movable contact 25, second contact device 202 including fixed terminal 21 including fixed contact 22, movable contactor 24 including movable contact 25, movable part 3 configured to move second movable contactor 24 between a third position and a fourth position, and contact accommodation part 4 accommodating fixed contact 22 and movable contact 25, first electromagnet device 501 configured to drive movable part 3 of first contact device 201, second electromagnet device 502 configured to drive movable part 3 of second contact device 202, housing 9 accommodating contact accommodation part 4 of first contact device 201 and contact accommodation part 4 of second contact device 202, thermal conduction member 6 (first part 61) provided between housing 9 and contact accommodation part 4 of first contact device 201, and thermal conduction member 6 (second part 62) provided between housing 9 and contact accommodation part 4 of second contact device 202. When movable contactor 24 of first contact device 201 is located at the first position, movable contact 25 and fixed contact 22 are separated from each other. When movable contactor 24 of first contact device 201 is located at the second position, movable contact 25 and fixed contact 22 are in contact with each other. When movable contactor 24 of second contact device 202 is located at the third position, movable contact 25 and fixed contact 22 are separated from each other. When movable contactor 24 of second contact device 202 is located at the fourth position, movable contact 25 and fixed contact 22 are in contact with each other.

According to the aspect, first contact device 201 and second contact device 202 in one electromagnetic relay unit 1 can each open and close the contacts. Furthermore, Joule heat generated at the contacts in each of first contact device 201 and second contact device 202 respectively easily dissipates from contact accommodation part 4, via thermal conduction member 6 and housing 9, to outside of electromagnetic relay unit 1.

In electromagnetic relay unit 1 according to another aspect, when movable contactor 24 of first contact device 201 is located at the first position, movable contactor 24 of second contact device 202 is located at the fourth position. When movable contactor 24 of first contact device 201 is located at the second position, movable contactor 24 of second contact device 202 is located at the third position.

According to the aspect, even when Joule heat generated at the contacts in first contact device 201 is transmitted, no Joule heat is generated at the contacts in second contact device 202. Thermal conduction member 6 can thus efficiently transmit Joule heat generated at the contacts in first contact device 201. Similarly, even when Joule heat generated at the contacts in second contact device 202 is transmitted, no Joule heat is generated at the contact in first contact device 201. Thermal conduction member 6 can thus efficiently transmit Joule heat generated at the contacts in second contact device 202.

In electromagnetic relay unit 1 according to another aspect, first contact device 201 is coupled to the power supply and the rechargeable battery.

The second contact device is coupled to the rechargeable battery and the electric motor.

According to the aspect, in the different two electric paths, i.e., the electric path between the power supply and the rechargeable battery and the electric path between the rechargeable battery and the electric motor, one electromagnetic relay unit 1 can open and close the contacts. The contacts may not be closed simultaneously in the two electric paths, preventing Joule heat from being generated simultaneously at the two contacts. Joule heat can thus further efficiently dissipate from electromagnetic relay unit 1.

In electromagnetic relay unit 1 according to another aspect, first part 61 of thermal conduction member 6 and second part 62 of thermal conduction member 6 are coupled to each other via thermal conduction member 6. First part 61 of thermal conduction member 6 and second part 62 of thermal conduction member 6 are integrally formed.

According to the aspect, Joule heat generated at the contacts in first contact device 201 can be transmitted to housing 9 via not only first part 61, but also second part 62. Similarly, Joule heat generated at the contacts in second contact device 202 can be transmitted to housing 9 via not only second part 62, but also first part 61. Joule heat generated at the contacts can thus further easily dissipate.

In electromagnetic relay unit 1 according to another aspect, housing 9 further accommodates first electromagnet device 501 and second electromagnet device 502. Third part 63 of thermal conduction member 6 is provided between housing 9 and first electromagnet device 501. Fourth part 64 of thermal conduction member 6 is provided between housing 9 and second electromagnet device 502.

According to the aspect, heat generated in electromagnet device 5 easily dissipates to outside of electromagnetic relay unit 1 via thermal conduction member 6 and housing 9.

In electromagnetic relay unit 1 according to another aspect, thermal conduction member 6 is made of resin.

According to the aspect, thermal conduction member 6 is easily formed in housing 9.

Electromagnetic relay unit 1 according to another aspect further includes seal material 7. Fixed terminal 21 is exposed from housing 9. Seal material 7 is provided to cover a gap between housing 9 and fixed terminal 21. Seal material 7 is provided between thermal conduction member 6 and a gap between housing 9 and fixed terminal 21.

According to the aspect, although housing 9 allows fixed terminal 21 to be exposed to outside of housing 9, seal material 7 can secure air tightness between housing 9 and fixed terminal 21.

In electromagnetic relay unit 1 according to another aspect, housing 9 has through hole 93. First part 61 (second part 62) of thermal conduction member 6 is in communication with outside of housing 9 via through hole 93.

According to the aspect, after the raw material of thermal conduction member 6 is placed from outside of housing 9, via through hole 93, into first space 81 (second space 82), thermal conduction member 6 can be produced in first space 81 (second space 82), easily producing thermal conduction member 6. Electromagnetic relay unit 1 including thermal conduction member 6 can thus be easily achieved.

In electromagnetic relay unit 1 according to another aspect, through hole 93 is provided at an end part of housing 9. Fixed terminal 21 is exposed from another end part opposite to the end part of housing 9.

According to the aspect, exposure opening 95 can allow fixed terminal 21 to be exposed externally. Furthermore, to produce thermal conduction member 6, by orienting exposure opening 95 downward, orienting through holes 93 upward, and placing the raw material of thermal conduction member 6 from through holes 93 into housing 9, the raw material can be easily supplied into first space 81 (second space 82). Furthermore, seal material 7 can suppress the raw material of thermal conduction member 6 from leaking from exposure opening 95.

In electromagnetic relay unit 1 according to another aspect, housing 9 has a plurality of through holes 93.

According to the aspect, to produce thermal conduction member 6, one of the plurality of through holes 93 can be utilized to place the raw material of thermal conduction member 6 into housing 9. Furthermore, the other of the through holes 93 can be utilized to urge gas in housing 9 to exit, while to urge the raw material to enter housing 9.

In electromagnetic relay unit 1 according to another aspect, housing 9 has opening 94. Housing 9 includes accommodation part 91 accommodating contact accommodation part 4 of first contact device 201, contact accommodation part 4 of second contact device 202, first electromagnet device 501, and second electromagnet device 502, and closure part 92 attached to accommodation part 91 to at least partially close opening 94.

According to the aspect, to produce thermal conduction member 6, thermal conduction member 6 can be disposed in housing 9 after contact accommodation parts 4 and electromagnet device 5 are installed from opening 94 into accommodation part 91.

In electromagnetic relay unit 1 according to another aspect, first electromagnet device 501 is located closer to opening 94 than contact accommodation part 4 of first contact device 201 is. Second electromagnet device 502 is located closer to opening 94 than contact accommodation part 4 of second contact device 202 is. First electromagnet device 501 and contact accommodation part 4 of first contact device 201 are arranged in the direction orthogonal to a direction in which the opening face of opening 94 expands. Second electromagnet device 502 and contact accommodation part 4 of second contact device 202 are arranged in the direction orthogonal to the direction in which the opening face of opening 94 expands.

In electromagnetic relay unit 1 according to another aspect, through hole 93 is provided on closure part 92.

According to the aspect, after opening 94 of accommodation part 91 is closed with closure part 92, through hole 93 can be utilized to place the raw material of thermal conduction member 6 in housing 9.

Electromagnetic relay system 10 according to an aspect of the present disclosure includes electromagnetic relay unit 1, and controller 11 configured to control electromagnet device 5.

According to the aspect, first contact device 201 and second contact device 202 respectively in one electromagnetic relay unit 1 can each open and close the contacts in accordance with control of controller 11. Furthermore, Joule heat generated at the contacts in each of first contact device 201 and second contact device 202 respectively easily dissipates from contact accommodation part 4, via thermal conduction member 6 and housing 9, to outside of electromagnetic relay unit 1.

What is claimed is:

1. An electromagnetic relay unit comprising:
a first contact device including
a first fixed terminal including a first fixed contact,
a first movable contactor including a first movable contact,
a first movable part configured to move the first movable contactor between a first position and a second position, and
a first contact accommodation part accommodating the first fixed contact and the first movable contact;
a second contact device including
a second fixed terminal including a second fixed contact,
a second movable contactor including a second movable contact,
a second movable part configured to move the second movable contactor between a third position and a fourth position, and
a second contact accommodation part accommodating the second fixed contact and the second movable contact;
a first electromagnet device configured to drive the first movable part;
a second electromagnet device configured to drive the second movable part;
a housing accommodating the first contact accommodation part and the second contact accommodation part;
a first thermal conduction member provided between the housing and the first contact accommodation part; and
a second thermal conduction member provided between the housing and the second contact accommodation part,
wherein,
when the first movable contactor is located at the first position, the first movable contact and the first fixed contact are separated from each other,
when the first movable contactor is located at the second position, the first movable contact and the first fixed contact are in contact with each other,
when the second movable contactor is located at the third position, the second movable contact and the second fixed contact are separated from each other, and
when the second movable contactor is located at the fourth position, the second movable contact and the second fixed contact are in contact with each other.

2. The electromagnetic relay unit according to claim 1, wherein,
when the first movable contactor of the first contact device is located at the first position, the second movable contactor of the second contact device is located at the fourth position, and,
when the first movable contactor of the first contact device is located at the second position, the second movable contactor of the second contact device is located at the third position.

3. The electromagnetic relay unit according to claim 1, wherein
the first contact device is coupled to a power supply and a rechargeable battery, and
the second contact device is coupled to the rechargeable battery and an electric motor.

4. The electromagnetic relay unit according to claim 1, wherein
the first thermal conduction member and the second thermal conduction member are coupled to each other via another thermal conduction member, and
the first thermal conduction member, the second thermal conduction member, and the other thermal conduction member are integrally formed.

5. The electromagnetic relay unit according to claim 1, further comprising:
a third thermal conduction member; and
a fourth thermal conduction member,
wherein
the housing further accommodates the first electromagnet device and the second electromagnet device,
the third thermal conduction member is provided between the housing and the first electromagnet device, and
the fourth thermal conduction member is provided between the housing and the second electromagnet device.

6. The electromagnetic relay unit according to claim 1, wherein the first thermal conduction member and the second thermal conduction member are made of resin.

7. The electromagnetic relay unit according to claim 1, further comprising a seal material, wherein
the first fixed terminal is exposed from the housing,
the seal material is provided to cover a gap between the housing and the first fixed terminal, and
the seal material is provided between the first thermal conduction member and the gap between the housing and the first fixed terminal.

8. The electromagnetic relay unit according to claim 1, wherein
the housing has a through hole, and
the first thermal conduction member is in communication with outside of the housing via the through hole.

9. The electromagnetic relay unit according to claim 8, wherein
the through hole is provided at an end part of the housing, and
the first fixed terminal is exposed from another end part opposite to the end part of the housing.

10. The electromagnetic relay unit according to claim 8, wherein
the housing has a plurality of through holes, and
the through hole is one of the plurality of through holes.

11. The electromagnetic relay unit according to claim 1, wherein
the housing has an opening, and
the housing includes
an accommodation part accommodating the first contact accommodation part of the first contact device, the second contact accommodation part of the second contact device, the first electromagnet device, and the second electromagnet device, and
a closure part attached to the accommodation part to at least partially close the opening.

12. The electromagnetic relay unit according to claim 11, wherein
the first electromagnet device is located closer to the opening than the first contact accommodation part is,
the second electromagnet device is located closer to the opening than the second contact accommodation part is,
the first electromagnet device and the first contact accommodation part are arranged in a direction orthogonal to a direction in which an opening face of the opening expands, and
the second electromagnet device and the second contact accommodation part are arranged in the direction orthogonal to the direction in which the opening face of the opening expands.

13. The electromagnetic relay unit according to claim 8, wherein
the housing has an opening,
the housing includes
an accommodation part accommodating the first contact accommodation part of the first contact device, the second contact accommodation part of the second contact device, the first electromagnet device, and the second electromagnet device, and
a closure part attached to the accommodation part to at least partially close the opening, and
the through hole is provided at the closure part.

14. An electromagnetic relay system comprising:
the electromagnetic relay unit according to claim 1; and
a controller configured to control the first electromagnet device and the second electromagnet device.
